(19) United States
(12) Patent Application Publication
(10) Pub. No.: US 2026/0295782 A1
(43) Pub. Date: Oct. 1, 2026

(54) SHAFT-DRIVEN EXTENSION WRENCH

(71) Applicant: Great Neck Saw Manufacturers, Inc., Memphis, TN (US)

(72) Inventor: Jeffrey G. Karl, Rossville, TN (US)

(73) Assignee: Great Neck Saw Manufacturers, Inc., Memphis, TN (US)

(21) Appl. No.: 19/463,635

(22) Filed: Jan. 29, 2026

Related U.S. Application Data
(60) Provisional application No. 63/754,393, filed on Feb. 5, 2025.

(51) Int. Cl. B25B 17/00; B25B 13/48

(52) U.S. Cl. CPC B25B 17/00; B25B 13/481

(57) ABSTRACT

A drive extension wrench is disclosed that includes a first end having a first connecting structure and a second end having a second connecting structure. A shaft defining a longitudinal rotational axis connects the first and second ends. Rotation of the first connecting structure along a first rotational axis is transferred through the shaft to cause rotation of the second connecting structure along a second rotational axis. In some embodiments, the wrench includes a housing that is separable at a coupling area to expose a portion of the shaft, allowing the shaft to be driven directly or to function as a modular attachment.

### CROSS-REFERENCE TO RELATED APPLICATIONS

This application claims the benefit of and priority to U.S. Application No. 63/754,393, filed Feb. 5, 2025, titled SHAFT-DRIVEN EXTENSION WRENCH, the entire disclosure of which is hereby incorporate by reference in its entireties and for all purposes.

### BACKGROUND

Hand tools, such as ratchets and sockets, can be used to turn fasteners (e.g., bolts, nuts, screws, etc.). In most cases, the application of a radial force on a ratchet may cause an axial rotation of the fastener. The radial force and the axial rotation may have the same axis of rotation. However, in certain environments (e.g., automative, etc.), it may be desirable to have different axes of rotation. For example, in order to access a hard-to-reach fastener, an extension wrench may be used to transfer a radial force from a ratchet having a first axis of rotation to a fastener having a second axis of rotation. Conventional extension wrenches formed from linked chains connected to drive gears may present challenges when used in certain applications (e.g., with power tools, impact drivers, and the like).

### BRIEF SUMMARY

One general aspect includes a drive extension wrench. The drive extension wrench includes a first end including a first connecting structure and defining a first rotational axis. The wrench also includes a second end including a second connecting structure and defining a second rotational axis. The wrench also includes a shaft defining a third rotational axis and being connected to the first connecting structure and the second connecting structure, where a third rotation of the shaft along the third rotational axis causes a first rotation along the first rotational axis and a second rotation along the second rotational axis.

Implementations may include one or more of the following features. The drive extension wrench where the first end further may include a first gear connected to the first connecting structure, and the second end further may include a second gear connected to the second connecting structure. The shaft may be directly connected to the first connecting structure via a first meshed connection between a first end of the shaft and the first gear, and directly connected to the second connecting structure via a second meshed connection between a second end of the shaft and the second gear. The shaft may include a third gear defined at the first end of the shaft and a fourth gear defined at the second end of the shaft, and where the first meshed connection is between the first gear and the third gear and the second meshed connection is between the second gear and the fourth gear. Each of the first gear, the second gear, the third gear, and the fourth gear may include a beveled gear. The bevel gear may include a helical beveled gear. Each of the first gear and the second gear may include a ring gear and each of the third gear and the fourth gear may include a pinion gear. The shaft may be disposed within the housing and the first connecting structure and the second connecting structure are accessible outside of the housing. The first connecting structure and the second connecting structure each may include a drive socket configured to releasably couple with a drive structure of a drive tool or a socket. The first end may include the first connecting structure is rotatable along the third rotational axis with respect to the second end may include the second connecting structure. The first rotational axis and the second rotational axis are about parallel with respect to each other, and the third rotational axis is about orthogonal to the first rotational axis and the second rotational axis. Application of a rotational force at the first connecting structure causes the first rotation, the second rotation, and the third rotation to occur at substantially the same time.

Another general aspect includes an apparatus. The apparatus may include a first rotating means defined at a first end of the apparatus and may include a first connecting structure. The apparatus also includes a second rotating means defined at a second end of the apparatus and may include a second connecting structure. The apparatus also includes a third rotating means connecting to the first rotating means and the second rotating means, where rotation of the first connecting structure is transferred to the second connecting structure via the third rotating means.

Another general aspect includes a drive extension wrench. The drive extension wrench may include a first end may include a first connecting structure and defining a first rotational axis. The wrench also includes a shaft defining a second rotational axis and being operably connected to the first connecting structure at a first end, where the shaft may include a second connecting structure at a second end, and where a first rotation of the second connecting structure along the second rotational axis causes a second rotation of the first connecting structure along the first rotational axis.

Implementations may include one or more of the following features. The drive extension wrench where the shaft is disposed within a housing, and the first connecting structure and the second connecting structure are each accessible outside of the housing. The first connecting structure and the second connecting structure each may include a socket or drive configured to releasably couple with a corresponding socket or drive a tool. The shaft may be operably connected to the first connecting structure via a shaft and ring gear assembly. The shaft may include a separable structure at an intermediate location, such that the shaft may be separated into two parts. The second connecting structure of the shaft may be configured to releasably couple with a corresponding structure of the second shaft portion. The second shaft portion may be operably connected to a third connecting structure at a distal end, the third connecting structure defining a third rotational axis substantially orthogonal to the second rotational axis.

### BRIEF DESCRIPTION OF THE DRAWINGS

FIG. 1 illustrates an isometric view of an example drive extension wrench, according to at least one example.

FIG. 2 illustrates an isometric view of the drive extension wrench with housing parts removed to reveal the internal shaft, according to at least one example.

FIG. 3 illustrates a cross-sectional view of the drive extension wrench through the longitudinal axis, according to at least one example.

FIG. 4 illustrates a perspective view of a separated portion of the drive extension wrench, according to at least one example.

FIG. 5 illustrates an isometric view of the drive extension wrench featuring an independently rotatable end that has been rotated approximately 90 degrees at a rotating zone, according to at least one example.

FIG. 6 illustrates a partial profile, zoomed-in view of the first end of the drive extension wrench, according to at least one example.

### DETAILED DESCRIPTION

A conventional drive extension wrench may include sprocket gears at either end of the wrench connected together with a drive chain. Application of a rotational force at one end of the wrench is transferred from a first sprocket to a second sprocket via the chain. Many modern day mechanics use power tools (e.g., impact drive wrenches, pneumatic drive wrenches, etc.), and such conventional drive extension wrenches may be unsuitable for use with such power tools. In particular, the chain is unable to transfer an impact load because the force of impact is lost in the chain links. Moreover, extended use of the conventional extension wrench may result in a slackened chain and worn out sprocket gears due to large rotational forces, which may be accelerated by the use of power tools. This slackening can result in increased wear from the chain rubbing along an inside of a housing of the wrench. It may also provide a poor user experience, especially when using a hand tool to drive the wrench.

The examples described herein relate to drive extension wrenches and methods for constructing and operating such wrenches. Examples of the drive extension wrenches described may include a drive shaft having geared ends that directly couple to corresponding gears at opposite ends of the wrench. This direct coupling of gears (e.g., without use of chains or a ratchet mechanism) to the drive shaft may enable the drive extension wrench to handle repeated loads from an impact wrench. Moreover, because the ends of the wrench are connected to an elongated drive shaft, each end may be rotated axially with respect to each other. This enables the axis of rotation of each end to be offset radially with respect to each other. For example, a first axis of rotation of a first end of the wrench may be at 0 degrees, while a second axis of rotation of a second end of the wrench may be offset 90 degrees. The functionality of a radial offset taken together with a longitudinal offset provides numerous options for accessing hard to reach fasteners.

In a particular example, described herein is an improved drive extension wrench designed to efficiently transfer rotational force between tools and fasteners, even in hard-to-reach or angular positions. The drive extension wrench may include a first end and a second end, each having a connecting structure, such as a drive socket, capable of engaging with a wide range of hand and power tools. These ends are connected by a central shaft, which is housed within a protective body and defines its own axis of rotation. The shaft connects to each end via a gear assembly, such as bevel, helical, ring, or pinion gears, enabling reliable and simultaneous rotation of both ends when force is applied to one side. This gear-driven architecture not only facilitates smooth transmission of torque but also provides the wrench with the structural integrity needed to withstand high torque loads and repeated impact use, addressing the limitations of conventional chain-driven extension wrenches.

In addition to the robust force transmission system, the described embodiment offers several features that enhance its adaptability and user-friendliness. The ends of the wrench can be positioned at various preset angles relative to the shaft, such as 22.5°, 45°, or 90°, allowing for flexible access to fasteners in tight or obstructed locations. The shaft may also include a separable structure, enabling the wrench to be split into two sections for servicing or alternative drive configurations. Retaining mechanisms, such as pins, ensure the shaft remains securely housed during operation, while the standardized drive sockets on each end ensure compatibility with common tools and sockets. Collectively, these features provide a durable, versatile, and easy-to-use extension wrench that meets the demands of both professional mechanics and do-it-yourself users, particularly when working in challenging environments or with modern impact tools.

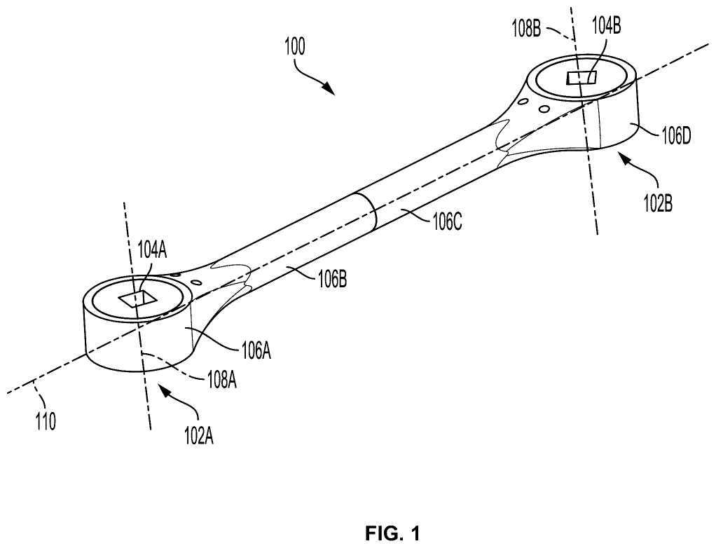

Turning now to the figures, FIG. 1 illustrates an isometric view of an example drive extension wrench 100, according to at least one example. The drive extension wrench 100 includes a first end 102A and a second end 102B. internal components of the drive extension wrench 100 are housed within a housing 106, which may be formed from multiple parts (e.g., 106A, 106B, 106C, and 106d) or may be one part. Each end 102 of the drive extension wrench 100 includes a connecting structure 104A, 104B. The connecting structures 104 are shown as being square openings extending through a circular wheel configured to receive standard square drives (e.g., ¼″, ⅜″, ½″, etc.) or any other standard coupler. In some examples, the connecting structures 104 may be any other suitable shape, structure, or the like to enable a drive mechanism (e.g., a wrench, ratchet, a pneumatic driver, an impact driver, etc.) to connect to the drive extension wrench 100. The connecting structures 104A and 104B may be configured to rotate within their respective housing parts 106A and 106D along respective axes of rotation 108A and 108B. The axes of rotation 108 may extend orthogonal with respect to a longitudinal axis 110. In some examples, the axes of rotation 108 may be more or less parallel with each other. As described further herein, the longitudinal axis 110 is also an axis of rotation of a shaft that connects the two connecting structures 104A and 104B. The longitudinal axis 110 may be offset orthogonally from the axes of rotation 108.

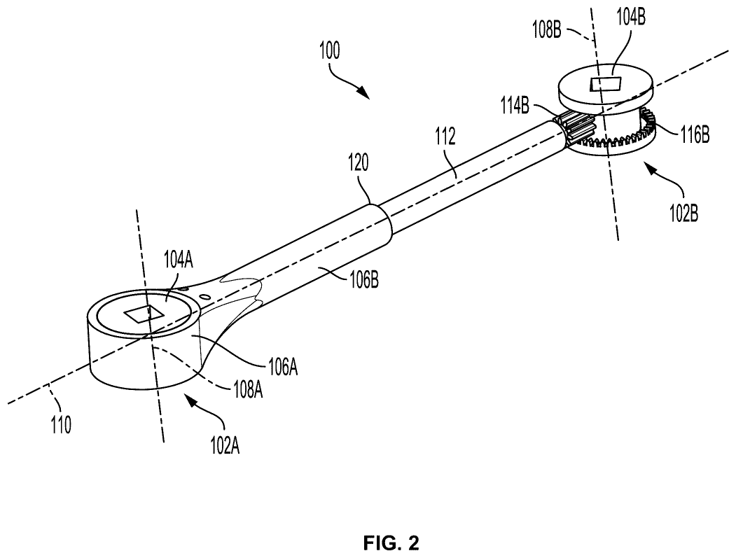

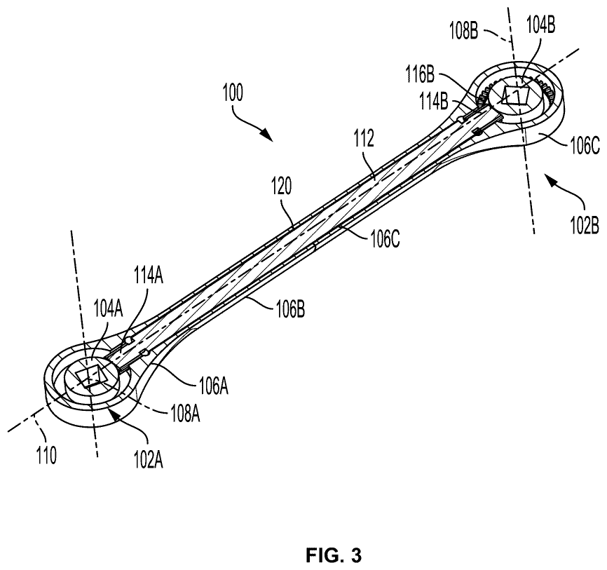

FIG. 2 illustrates an isometric view of the drive extension wrench 100 with the housing parts 106C and 106D removed to illustrate a shaft 112 and other internal components of the drive extension wrench 100, according to at least one example. While FIG. 2 depicts the second end 102B of the drive extension wrench 100, the first end 102A may be similarly configured. The shaft 112 may be aligned with the longitudinal axis 110 and may extend between the first end 102A and the second end 102B within the housing 106. The shaft 112 may be connected to each of the connecting structures 104. For example, the shaft 112 includes a shaft gear 114B that engages with a ring gear 116B connected to the second connecting structure 104B. The shaft gear 114B and the ring gear 116B may create a mesh connection between teeth of the respective gears in order to transfer rotational forces therebetween. For example, rotation about the rotational axis 108B may cause the ring gear 116B to rotate, which, because of the mesh connection between the ring gear 116B and the shaft gear 114B, will cause the shaft 112 to rotate about the longitudinal axis 110 (e.g., about orthogonal to the first rotational axis 108B). The rotation of the shaft 112 may cause the connecting structure 104A to rotate by virtue of a mesh connection between the shaft gear 114A and the ring gear 116A, as shown in more detail in FIG. 3. FIG. 3 illustrates a cross-sectional view of the drive extension wrench 100 through the longitudinal axis of the drive extension wrench 100, according to at least one example. In practice, a radial force applied to the connecting structure 104A (e.g., from a drive wrench) may be converted into an axial force along the shaft 112 and then transferred to a fastener via rotation of the second connecting structure 104B.

The ring gear 116B may be connected to the connecting structure 104B in any suitable manner (e.g., welded, pressed, glued, held with threads, etc.) or may be integrally formed with the connecting structure 104B. In the illustrated example, the shaft gear 114B is a pinion gear that engages with the ring gear 116B. In some examples, a set of bevel gears may be used in place of the shaft gear 114B and the ring gear 116B. In some examples, bevel gears, including those thar are helical, may be suitable for carrying larger rotational forces, as compared to ring and pinion gear sets. The connecting structure 104B is illustrated as being as having a spool shape to account to give a recess clearance for the shaft gear 114B to engage with the ring gear 116B.

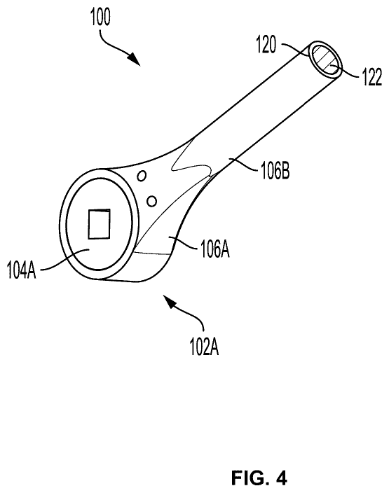

As shown in FIG. 2, the housing parts 106B and 106C may together define a coupling area 120. In some examples, the drive extension wrench 100 may be separable (e.g., releasable) at the coupling area 120. For example, as shown in FIG. 4, the part consisting of housing parts 106A and 106B may be separated from the part consisting of housing parts 106C and 106D to provide an adaptable extension wrench. In this example, the drive extension wrench 100 may include a separable structure 122 in the coupling area 120 and connected to the shaft 112. This separable structure 122 may include a socket or drive (e.g., a male or female structure) configured to mate with a corresponding drive or socket (e.g., separable structure 122) of the shaft 112. In this manner, the shaft 112 may be separable into two parts, each of which (or at least one of which) may be connected to a drive and driven like the connecting structure 104. In some examples, the separable structures 122 may include a retention mechanism to ensure that they remain connected when desired and which can be actuated to separate the two parts. For example, a detent mechanism, a ball and socket with a spring, a set screw, set pins, and any other comparable mechanism or structure may be used. The drive extension wrench 100 illustrated in FIG. 4 may be desirable to provide an alternative drive direction. For example, a driver may be connected to drive directly to the end of the shaft 112 to drive the connecting structure 104A, much like a 90 degree angle drive attachment.

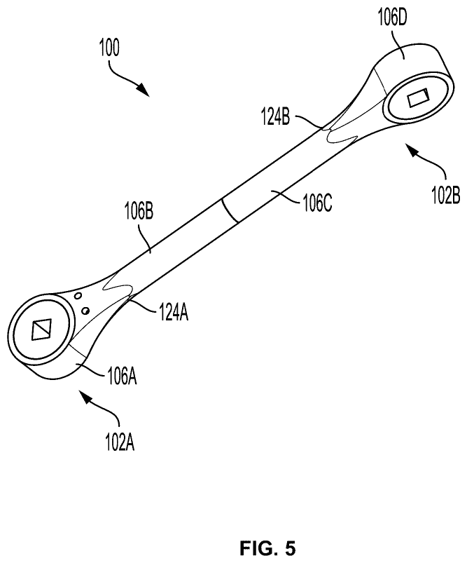

FIG. 5 illustrates an example of the drive extension wrench 100 that includes an independently rotatable end 102, according to at least one example. In some examples, the drive extension wrench 100 may be configured such that one or both of the ends 102 is independently rotatable. For example, as shown in FIG. 5, the end 102B has been rotated about 90 degrees with respect to the end 102A. In some examples, this may be desirable to provide an additional drive direction from which to approach the end 102A, 102B. In some examples, the housing part 106D may be rotatable with respect to the housing part 106C at a rotating zone 124B. In some examples, in the rotating zone 124B may be defined any suitable mechanism to enable the end 102B to releasably rotate. For example, the end 102B may be configured to rotate within one or more preset angles (e.g., 22.5, 45, 90, etc.).

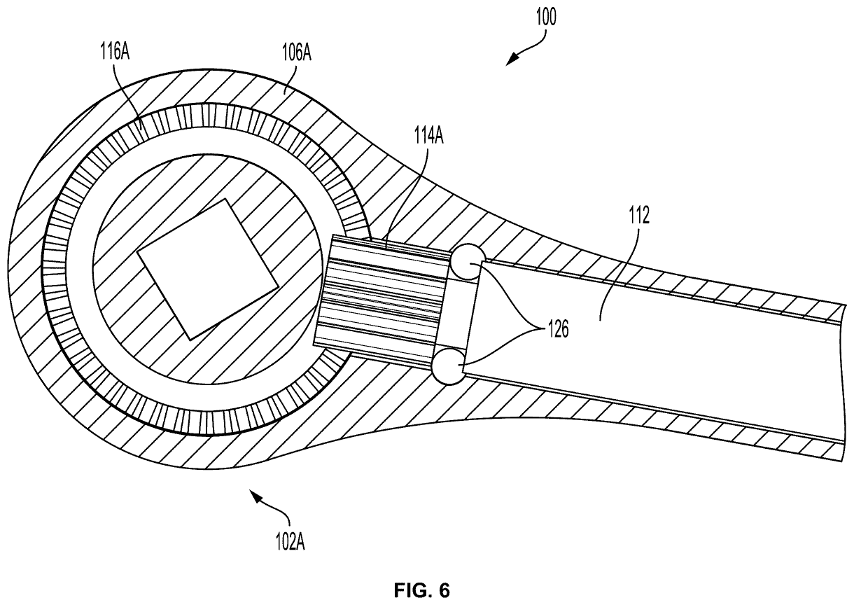

FIG. 6 illustrates a zoomed-in view of the end 102A of the drive extension wrench 100 in a partial profile view, according to at least one example. The profile view in FIG. 6 illustrates a set of retaining structures 126 that are used to retain the shaft 112 within the housing 106. In some examples, the pin structures 126 may be provided on both ends of the drive extension wrench 100 between a body of the shaft 112 and near distal ends of the shaft 112 that include the shaft gears 114. In some examples, the pin structures 126 may be positioned to minimize the longitudinal distance between the pin structures and a distal end of the shaft gear 114. The pin structures 126 may extends from side to side through the housing 106 and may be held within openings in the housing 106 via a pressed fit, screws, expansion springs, glue, fastener, or any other suitable approach.

In some examples, interior components of the drive extension wrench 100 may be greased or otherwise lubricated via one or more ports disposed on the housing 106. In some examples, the drive extension wrench 100 is entirely sealed, including with rubber gaskets or other means of preventing water ingress and oil/grease egress. In some examples, certain portions of the drive extension wrench 100 may be serviceable using common tools or specialized tools.

The gears, shaft, connecting structure, and other moving parts may be formed from hardened steel or other such material. The body may be formed from hardened plastic, chromoly, hardened steal, or other such material.

In some examples, different versions and/or sizes of the drive extension wrench 100 may be contemplated. For example, a first version may be suitable for 5-50 nanometers of torque (e.g., driven by a ¼″ drive), a second version may be suitable for 50 -150 nanometers of torque (e.g., driven by ⅜″ drive), and a third version may be suitable for 150-300 nanometers of torque (e.g., driven by a ½″ drive).

A method of assembling the drive extension wrench 100 may include providing a multi-part housing, which may include housing parts 106A, 106B, 106C, and 106D, designed to enclose and protect the internal drive components. These segments may be manufactured from hardened materials such as plastic or chromoly to withstand mechanical stress during operation.

The method of assembling the drive extension wrench 100 may include integrating the connecting structures by seating a first connecting structure 104A within the first housing part 106A and a second connecting structure 104B within the distal housing part 106D. These structures may be configured as circular wheels with square openings to receive standard square drives, such as ¼″, ⅜″, or ½″ tools.

The method of assembling the drive extension wrench 100 may include affixing ring gears by connecting ring gears 116A and 116B to their respective connecting structures (104A and 104B) using methods such as welding, press-fitting, gluing, or threaded engagement. Alternatively, the ring gears may be integrally formed with the connecting structures to ensure a rigid and durable connection for torque transfer.

The method of assembling the drive extension wrench 100 may include aligning the drive shaft by positioning the shaft 112 along the longitudinal axis 110 within the internal cavity defined by the housing 106. The shaft may server as the primary mechanical link between the first and second ends of the wrench, converting radial force into axial rotation.

The method of assembling the drive extension wrench 100 may include establishing mesh connections by bringing the shaft gears 114A and 114B, located at the distal ends of the shaft 112, into a direct mesh connection with the corresponding ring gears 116A and 116B. This mesh connection between the teeth of the pinion and ring gears may allow for the efficient transfer of high-torque loads, suitable for use with impact drivers.

The method of assembling the drive extension wrench 100 may include securing the shaft by install retaining structures 126, such as pin structures or screws, through the housing 106 and positioning them near the distal ends of the shaft gears 114. These pins may be secured via a pressed fit or fasteners to minimize longitudinal movement and retain the shaft 112 securely within the body.

The method of assembling the drive extension wrench 100 may include establishing the coupling area, which may include, for modular embodiments, coupling the segments of the shaft 112 using a separable structure 122 at the designated coupling area 120. This may involve mating a male or female drive structure and securing them with a retention mechanism, such as a detent ball and spring, to ensure the segments remain connected until manual separation is desired.

The method of assembling the drive extension wrench 100 may include enclosing and lubricating by securing the housing parts together using common or specialized fasteners to create a sealed environment. Lubrication may be provided initially before securing the housing parts or via provided ports. Enclosing may also include applying rubber gaskets where necessary to prevent water ingress and oil or grease egress.

In various embodiments, the “rotating means” recited herein may include, but are not limited to, any structure or combination of structures capable of receiving and/or transmitting rotational motion. For example, the rotating means may include a drive socket, a polygonal aperture, a splined shaft, a rotary lug, or any other mechanical interface capable of coupling with a drive tool or fastener. The rotating means may further include or be operatively connected to one or more gear assemblies, such as bevel gears, helical gears, ring gears, pinion gears, worm gears, or planetary gears, which serve to transfer rotational force between axes that are parallel, orthogonal, or otherwise offset relative to each other. In certain embodiments, the rotating means may also include support components such as bearings, bushings, thrust washers, or rotary seals, which facilitate smooth rotation and enhance durability under high-load or impact conditions.

In certain embodiments, the rotating means may further include features that allow for preset or adjustable angular positioning relative to the connecting means or housing. These features may include detent mechanisms, rotary indexing assemblies, friction clutches, or angular locking systems, enabling the tool ends to be positioned and maintained at discrete angles (e.g., 22.5°, 45°, 90°) relative to the central shaft. Support for the rotating means may be provided by bushings, rolling element bearings, or journal bearings, which reduce friction and wear during repeated use, particularly under impact or high-torque conditions. The housing may incorporate lubrication channels, grease fittings, or sealing elements (such as O-rings or gaskets) to ensure long-term reliability and ease of maintenance.

The “connecting means” described herein may include an elongated shaft, torque rod, or drive spindle configured to transmit rotational motion between the first and second rotating means. The shaft may be a rigid, segmented, or telescoping structure formed from metal, composite, or other high-strength materials suitable for repeated torque transfer. In some embodiments, the connecting means may further include or be replaced by flexible couplings, universal joints, torque tubes, or articulated linkages, enabling the transmission of rotation even where the axes of the rotating means are non-collinear or variable. The connecting means may include integrated or attached gear elements at one or both ends, facilitating meshed engagement with corresponding gears or other rotational transmission components. Additionally, modular or separable configurations are contemplated, wherein the shaft or connecting means can be disassembled or reconfigured to accommodate different operational modes, servicing, or alternative tool attachments.

In further embodiments, the connecting means may be configured as a modular or serviceable component. For example, the shaft or torque-transmitting member may be separable at an intermediate coupling, permitting replacement, repair, or reconfiguration with alternative drive sections. Such modular couplings may be achieved using keyed shafts, splined interfaces, threaded connections, or quick-release mechanisms, and may include retention devices such as detent balls, spring pins, or set screws to maintain engagement during operation. The modular design facilitates customization for different drive lengths, tool interfaces, or torque requirements, thereby enhancing the adaptability and utility of the extension wrench across a range of applications.

It should be understood that the structures described for the rotating means and connecting means are exemplary and not limiting. The present disclosure expressly contemplates alternative and equivalent structures that perform substantially the same function in substantially the same way to achieve substantially the same result. For example, the rotating means may include, in addition to the specifically recited gear assemblies and drive sockets, mechanisms such as clutches, rotary actuators, splined couplings, or quick-release adapters. Similarly, the connecting means may include flexible drive shafts, cable-driven systems, or any other mechanism capable of transmitting rotational energy between two points, regardless of their spatial orientation or the presence of intervening components. Such alternatives are intended to fall within the scope of the appended claims, whether or not explicitly shown in the drawings.

The foregoing description of the rotating means, connecting means, and associated components is provided to ensure support for means-plus-function claim elements under 35 U.S.C. § 112(f). The structures described herein, including sockets, gears, shafts, couplings, and their equivalents, are intended to provide full written description and enablement for all claimed functions, and the claimed subject matter should not be construed as limited to the specific examples set forth above.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A drive extension wrench, comprising:
a first end comprising a first connecting structure and defining a first rotational axis;
a second end comprising a second connecting structure and defining a second rotational axis; and
a shaft defining a third rotational axis and being connected to the first connecting structure and the second connecting structure, wherein a third rotation of the shaft along the third rotational axis causes a first rotation along the first rotational axis and a second rotation along the second rotational axis.

2. The drive extension wrench of claim 1, wherein the first end further comprises a first gear connected to the first connecting structure, and the second end further comprises a second gear connected to the second connecting structure.

3. The drive extension wrench of claim 2, wherein the shaft is directly connected to the first connecting structure via a first meshed connection between a first end of the shaft and the first gear, and directly connected to the second connecting structure via a second meshed connection between a second end of the shaft and the second gear.

4. The drive extension wrench of claim 3, wherein the shaft comprises a third gear defined at the first end of the shaft and a fourth gear defined at the second end of the shaft, and wherein the first meshed connection is between the first gear and the third gear and the second meshed connection is between the second gear and the fourth gear.

5. The drive extension wrench of claim 4, wherein each of the first gear, the second gear, the third gear, and the fourth gear comprises a beveled gear.

6. The drive extension wrench of claim 5, wherein the bevel gear comprises a helical beveled gear.

7. The drive extension wrench of claim 4, wherein each of the first gear and the second gear comprise a ring gear and each of the third gear and the fourth gear comprises a pinion gear.

8. The drive extension wrench of claim 1, further comprising a housing, and wherein the shaft is disposed within the housing and the first connecting structure and the second connecting structure are accessible outside of the housing.

9. The drive extension wrench of claim 1, wherein the first connecting structure and the second connecting structure each comprise a drive socket configured to releasably couple with a drive structure of a drive tool or a socket.

10. The drive extension wrench of claim 1, wherein the first end comprising the first connecting structure is rotatable along the third rotational axis with respect to the second end comprising the second connecting structure.

11. The drive extension wrench of claim 1, wherein the first rotational axis and the second rotational axis are about parallel with respect to each other, and the third rotational axis is about orthogonal to the first rotational axis and the second rotational axis.

12. The drive extension wrench of claim 1, wherein application of a rotational force at the first connecting structure causes the first rotation, the second rotation, and the third rotation to occur at substantially the same time.

13. An apparatus, comprising:
a first rotating means defined at a first end of the apparatus and comprising a first connecting structure;
a second rotating means defined at a second end of the apparatus and comprising a second connecting structure; and
a third rotating means connecting to the first rotating means and the second rotating means, wherein rotation of the first connecting structure is transferred to the second connecting structure via the third rotating means.

14. A drive extension wrench, comprising:
a first end comprising a first connecting structure and defining a first rotational axis; and
a shaft defining a second rotational axis and being operably connected to the first connecting structure at a first end, wherein the shaft comprises a second connecting structure at a second end, and wherein a first rotation of the second connecting structure along the second rotational axis causes a second rotation of the first connecting structure along the first rotational axis.

15. The drive extension wrench of claim 14, wherein the shaft is disposed within a housing, and the first connecting structure and the second connecting structure are each accessible outside of the housing.

16. The drive extension wrench of claim 14, wherein the first connecting structure and the second connecting structure each comprise a socket or drive configured to releasably couple with a corresponding socket or drive a tool.

17. The drive extension wrench of claim 14, wherein the shaft is operably connected to the first connecting structure via a shaft and ring gear assembly.

18. The drive extension wrench of claim 14, wherein the shaft comprises a separable structure at an intermediate location, such that the shaft may be separated into two parts.

19. The drive extension wrench of claim 14, further comprising a second shaft portion, wherein the second connecting structure of the shaft is configured to releasably couple with a corresponding structure of the second shaft portion.

20. The drive extension wrench of claim 19, wherein the second shaft portion is operably connected to a third connecting structure at a distal end, the third connecting structure defining a third rotational axis substantially orthogonal to the second rotational axis.
